(19) United States
(12) Patent Application Publication
(10) Pub. No.: US 2022/0005310 A1
(43) Pub. Date: Jan. 6, 2022

(54) Method for Executing a User-Guided Lottery

(71) Applicant: Ahmed Abdel Ghaffar, Brooklyn, NY (US)

(72) Inventor: Ahmed Abdel Ghaffar, Brooklyn, NY (US)

(21) Appl. No.: 17/368,790

(22) Filed: Jul. 6, 2021

Related U.S. Application Data
(60) Provisional application No. 63/048,565, filed on Jul. 6, 2020.

(51) Int. Cl. G07F 17/32

(52) U.S. Cl. CPC G07F 17/329; G07F 17/3258; G07F 17/3281; G07F 17/3213

(57) ABSTRACT

A method for executing a user-guided lottery uses a set of user groups that are managed by a remote server and each include a selection criteria. The method further employs a set of user accounts that are associated to computer devices and financial accounts. Additionally, the user account includes user eligibility information. The method begins after receiving an interaction requests from an arbitrary account with the remote server. The method continues by executing a user verification process for the arbitrary account with the remote server in order to identify at least one matching group. Once verified, the method continues by executing a lottery configuration process for the matching group with the remote server in order to determine a buy-in amount and an event window. The method concludes by executing a randomized selection process and displaying a visual representation of the randomized selection process with the computing device.

The current application claims a priority to the U.S. Provisional Patent application Ser. No. 63/048,565 filed on Jul. 6, 2021.

### FIELD OF THE INVENTION

The present invention relates generally to a virtual platform comprising a random lottery module for a user group from a plurality of user accounts. The virtual platform provides a user interface environment where a plurality of user accounts access and interact with the virtual by chatting and participating in a random lottery module.

### BACKGROUND OF THE INVENTION

From the times of the ancient Babylonians, the Egyptians, the Greeks and the Romans raffle-like games and lotteries have been a popular way to draw winners for community prizes. Over time, these simple games of chance evolved to provide huge levels of fundraising. For example, the Hun dynasty in China developed Keno, and the money from its draws funded immense civil and defense projects.

Another instance is when the Flemish artist Jan Van Eyck died in 1446. Van Eyck's widow decided to raffle off her late husband's works, selling raffle tickets and thus holding the first recognizable raffle in history. After 1446, raffles became incredibly popular as they could provide the funding for almost any cause.

During the late 1460s Belgium funded a wide range of civic projects, public facilities and churches, with raffle-like events, which served the needs of the people. Florence was the site of Italy's first lottery in the 1500s and Queen Elizabeth I held a raffle where prizes included cash, china and a grand tapestry.

From this point onward, lotteries and raffles have been a common sight in historical records throughout Europe. The Netherlands set up a lottery in 1727 and it still goes on today, making it the longest running lottery in history.

Shortly after, raffles and lotteries were brought to North America, and the first raffle in the USA was held in Virginia in 1612. All the proceeds went back into building the community, much like raffle funds do today.

Charities, community groups, schools, churches and clubs all hold raffle events on a regular basis in order to reliably and easily raise funds for projects that will benefit the whole community.

It is therefore the objective of the present invention to provide a virtual platform where a plurality of user accounts participates in random lottery modules, where a random winner is selected from the plurality of user accounts. The selected winner has the option of donating the entire proceeds, part of the proceeds or none of the proceeds to a charity or fundraiser of their choice.

### SUMMARY OF THE INVENTION

The present invention relates generally to a virtual platform comprising a random lottery module for a user group from a plurality of user accounts. The virtual platform comprises an initializing phase which allows for identification and human verification of the plurality of user accounts. The initializing phase allows a user account to register and interact with the virtual platform after the initializing phase is complete.

After the initializing phase is complete, the user account has the ability of initializing a group generation module. The group generation module allows a user account to generate a group and send invitations to other user accounts. The plurality of user accounts that are invited to the user group have the option of accepting or rejecting the invitation.

Similarly, user groups are not limited to user-to-user invitations, the virtual platform also comprises a user group suggestion engine which relays information regarding the active plurality of user groups to the active plurality of user accounts on the virtual platform. Therefore, the user account joins suggested user groups by the virtual platform, or from the user-to-user invitation process.

When a user group is stablished and user accounts are ready, the plurality of user accounts from the user group determines a selected amount for a buy-in and a designated event time slot. The selected amount for the buy-in is an amount agreed upon by the plurality of user accounts from the user group.

When the selected amount for the buy-in is stablished, every user account transfers the buy-in amount into a shared pot. The designated event time slot comprises of a time and a date selected by the user group. The designated event time slot is the period of time in which the random lottery module is initialized.

The random lottery modules comprise a visual guide. The visual guide comprises a rotating wheel divided into a plurality of slots comprising a plurality of names related to the plurality of user accounts from the user group.

During the random lottery modules, the visual guide initializes the process with the rotating wheel. When the wheel stops rotating a maker located on the rotating wheel points to the name of the selected winner.

The winner from the user group then collects the total amount of the plurality of buy-ins from the shared pot. A percentage of the total amount of the plurality of buy-ins is transferred to a service fund which is allocated to the virtual platform for standard services and operations fees.

All components and features are described in detail in the following section. Any variation, or slight modification of the present invention is to be considered within the scope of the invention.

Additionally, the embodiments figures and drawings are merely examples and are not intended to limit the scope of the invention in any shape, way or form. Therefore, it is intended that the present invention covers all other embodiments that are within the scope of the appended claims and their equivalents.

The virtual platform provides a user interface environment from a user interface environment generator. A plurality of user accounts access and interact the virtual platform in order to chat and participate in a random lottery module.

First, a user account must be created, registered, and verified, this is the initializing phase. The initializing phase is crucial; thus, it allows to verify the identity of the plurality of user accounts, thus avoiding breach in cybersecurity. When the user account has completed the initializing phase, the user account is presented with a home page.

The home page allows a user account to select or modify various modules from the virtual platform. One of the modules is a group generation module. In this case, the group generation module allows a user account to create a user group.

The user group is a plurality of user accounts that have accepted the invitation to become members of the user group. A user account has the option of accepting or denying an invitation to a user group.

Additionally, the plurality of user accounts also has the option to chat and send messages to other user accounts via the chat module. When the user group is established and ready to continue, the user group determines a selected amount for a buy-in. The amount selected by the user group for the buy-in is collected from every user account and temporarily held in a shared pot.

The shared pot comprises the plurality of buy-ins from every user account within that user group. When every buy-in is collected from every user account, the user groups set a designated event time slot. The designated event time slot comprises a time and a date for a random lottery module.

The random lottery module comprises a lottery wheel divided into a plurality of sections. The plurality of sections comprises a plurality of names associated to the plurality of user accounts for the corresponding user group. Therefore, during the designated event time slot, every user account from the user group has the ability of logging into the virtual platform to observe the random lottery module occur during live time. Similarly, a user account does not need to be logged into the virtual platform to observe the random lottery module occur.

If a user account is selected as a winner from the random lottery module, and the user account is not logged in during the random lottery module, the user account gets a notification from a notification generation engine, notifying they were selected as the winner for the random lottery module. Additionally, a user group is not limited only to invitations from user-to-user account.

The virtual platform also generates user group suggestions to the plurality of user accounts that have been registered and verified. The virtual platform generates user group suggestions via a user group suggestion engine which relays information regarding the active plurality of user groups to the active plurality of user accounts on the virtual platform. Additionally, a service percentage from the total amount of the plurality of buy-ins is allocated and transferred to a service fund.

The service fund is a percentage of the plurality of buy-ins which is designated to the virtual platform as a standard fee for services and operations. The preferred embodiment for the present invention is in the form of a mobile application. The mobile application is supported for all operating systems for all smart devices.

Additionally, the present invention also comprises website capabilities and compatibility with the virtual platform, thus making it accessible via Personal Computers (PC) and other stationary machines. All information from the plurality of user accounts is stored and protected in a cloud-based remote server. Additionally, the user account that creates the user group and initializes the random lottery module qualifies to receive a bonus. Furthermore, the random lottery module also includes as possible embodiments a wheel and ball tank, as well as big numbers.

The invention has been explained in relation to its preferred embodiment, but it is to be understood that many other possible modifications and variations can be made without departing from the spirit and scope of the invention. Obvious changes, modifications and substitutions may be made by those skilled in the art to achieve the same purpose of the invention.

### BRIEF DESCRIPTION OF THE DRAWINGS

FIG. 1 is a block diagram illustrating the system overview of the present invention.

FIG. 2 is a flowchart describing the overall process followed by the method of the present invention.

FIG. 3 is a flowchart describing a process for appending a user account to a matching user group through the method of the present invention.

FIG. 4 is a flowchart describing a process for creating a new user group through the method of the present invention.

FIG. 5 is a flowchart describing a process for providing a bonus incentive to a user group creator through the method of the present invention.

FIG. 6 is a flowchart describing a process for calculating and extracting the final buy-in amount through the method of the present invention.

FIG. 7 is a flowchart describing a process for transferring the reward pool to the winning account through the method of the present invention.

FIG. 8 is a flowchart describing a process for subtracting a service fund from the reward pool before transfer to the winning account through the method of the present invention.

FIG. 9 is a flowchart describing a process for notifying the winning account through the method of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for facilitating managing of paths for unmanned vehicles, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

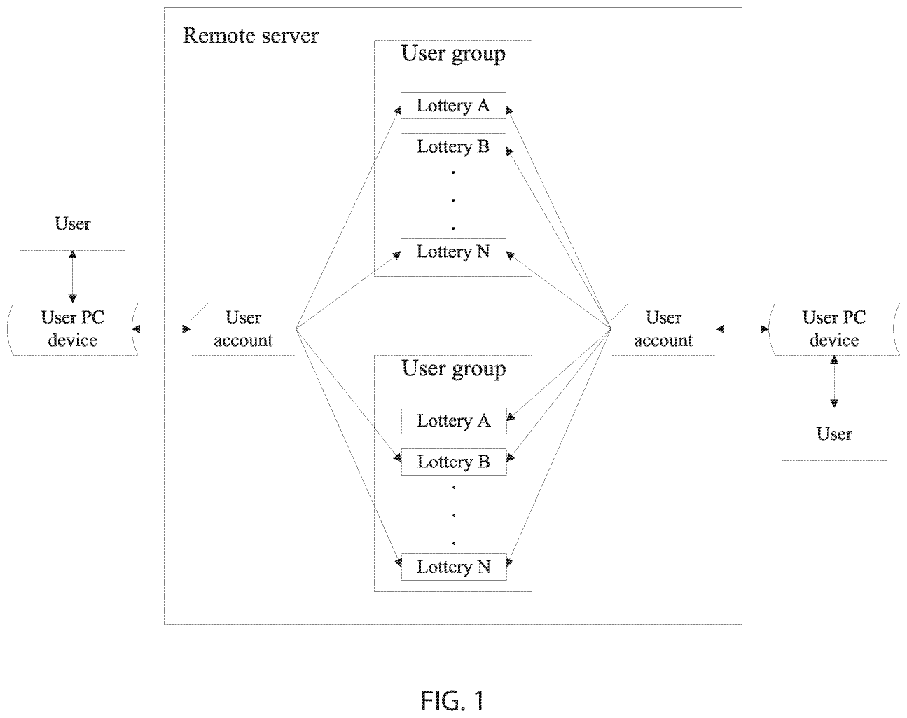

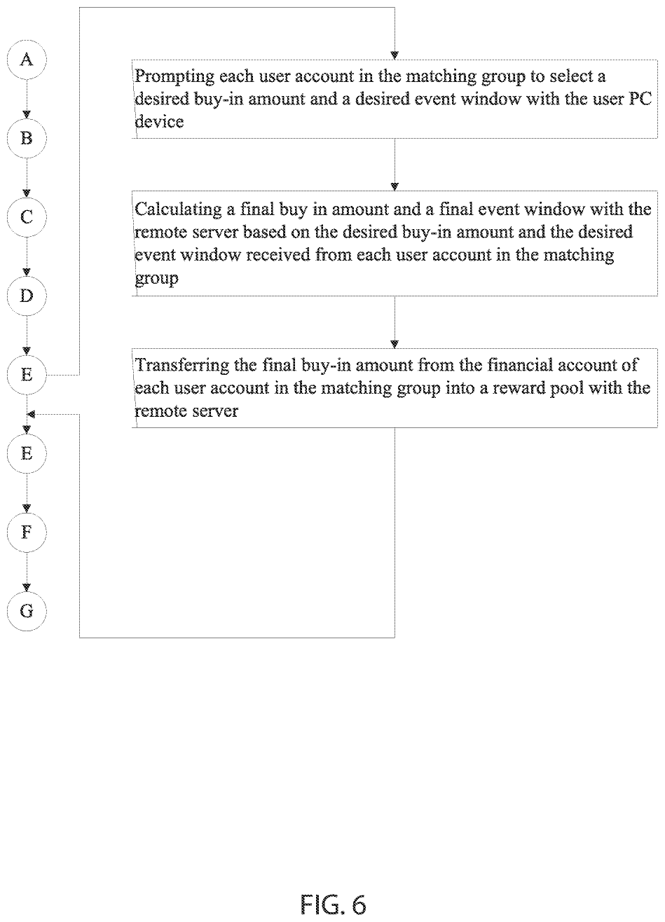

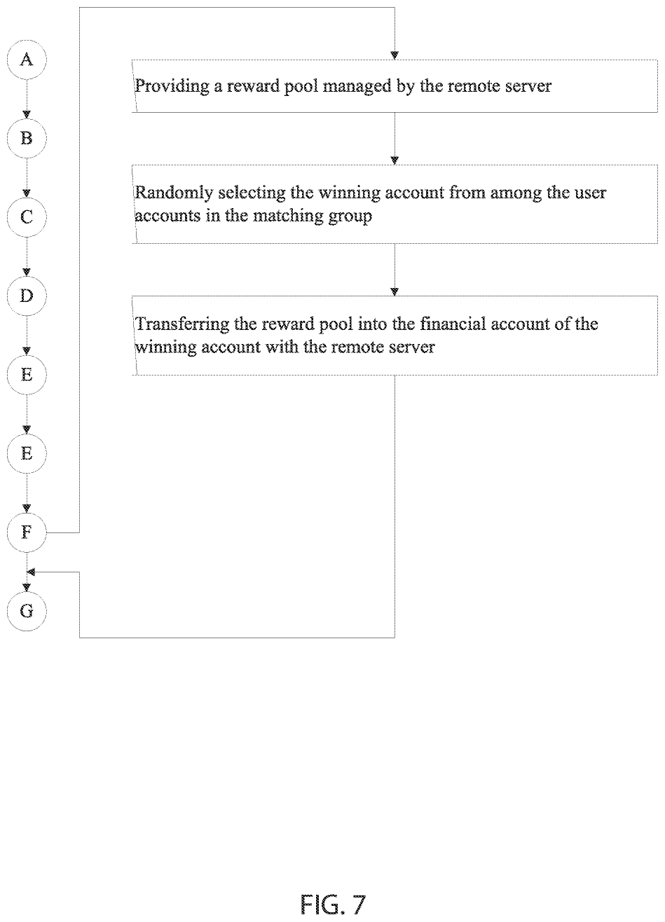

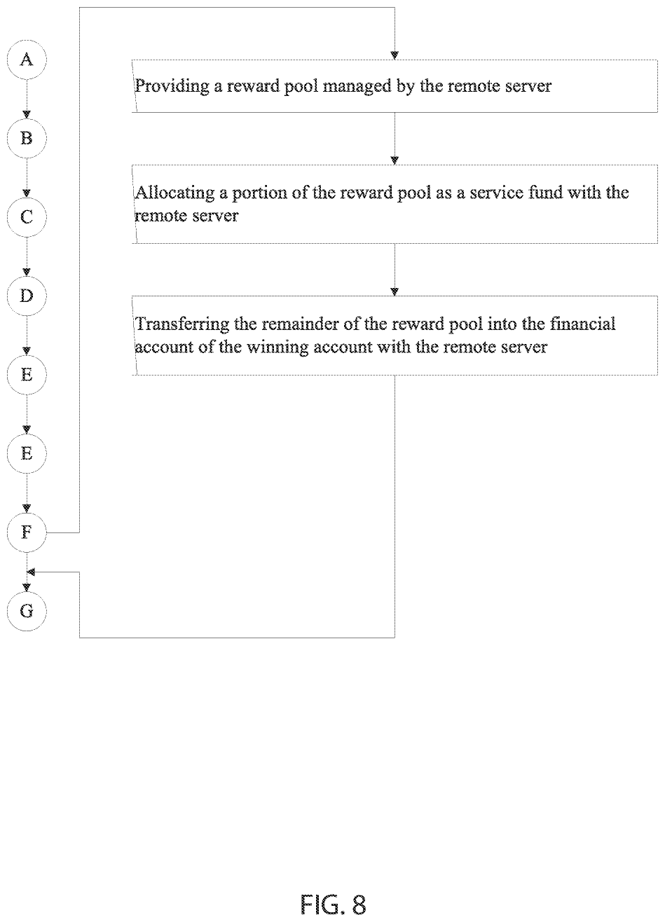

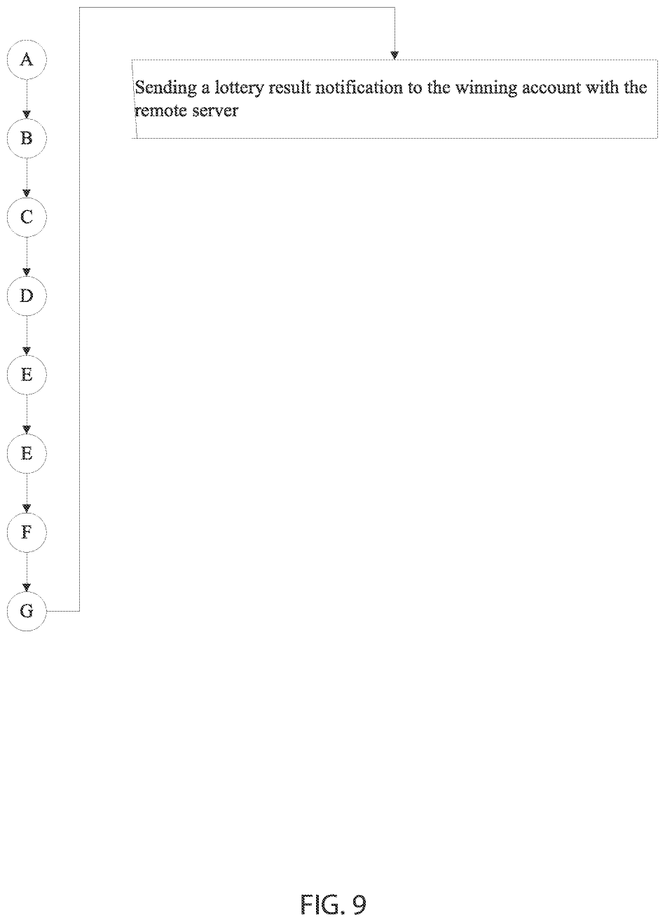

Referring to FIG. 1 through FIG. 9, the present invention is a method for executing a user-guided lottery that enables a user to join one or more lotteries thar are hosted by one or more other users. Additionally, the method of the present invention enables groups of users to decide on the cost of entry as well as the time and date that the lottery will take place. Thus, enabling groups of users to perform targeted fundraising operations. The present invention enables a user to create a lottery group and invite others to join in. Additionally, the present invention is designed to suggest different lotteries to the user. Thereby, enabling the user to participate in a wide variety of lotteries. Further, the method of the present invention is designed to enable the user to participate in multiple concurrently running lotteries.

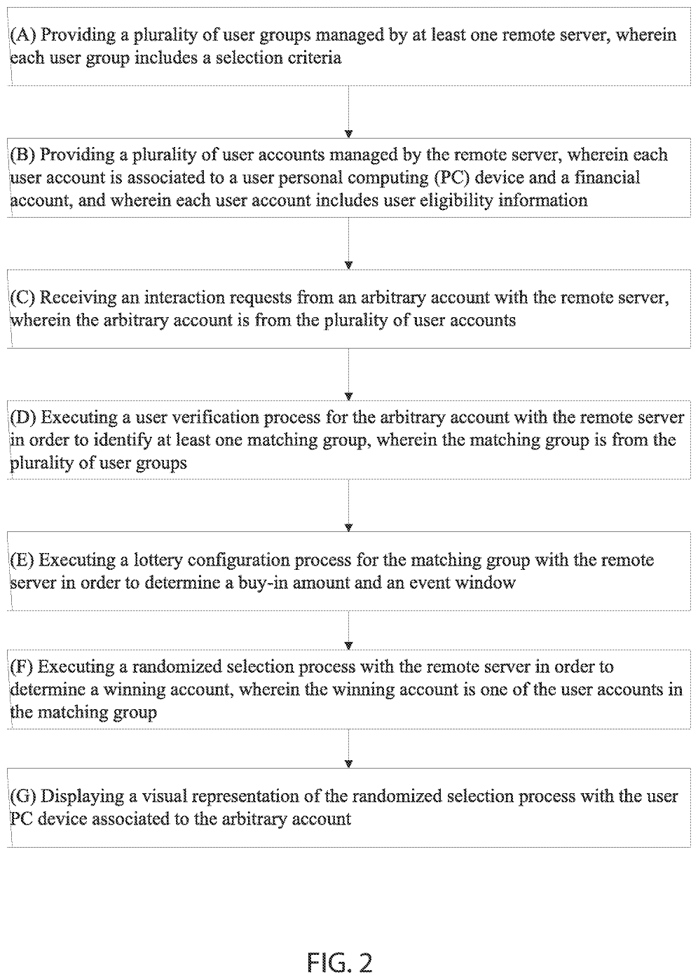

Referring to FIG. 1 and FIG. 2, to achieve the above-described functionalities, the system for executing the method of the present invention provides a plurality of user groups managed by at least one remote server (Step A). The term “remote server” is used herein to refer to a computing system capable of managing communication between the distributed network of components used to execute the method of the present invention. Additionally, the remote server is tasked with performing a number of internal processes required to execute the method of the present invention. Each user group includes a selection criteria that is used to determine whether or not a user is eligible to enter the lottery associated with said user group. The system for executing the method of the present invention further provides a plurality of user accounts managed by the remote server (Step B). Each user account is a virtual representation of a user and is associated to a user personal computing (PC) device and a financial account. The user PC device is an electronic system capable of interacting with, and executing various steps of, the method of the present invention. The user PC device is at least one system selected from the group comprising a smart-phone, a laptop, a desktop, or a tablet PC. Each user account further includes user eligibility information that is used to determine what types of lotteries the user account is able to access. It is possible for the user's eligibility information to satisfy the selection criteria for multiple user groups. As a result, the user account is able to access and enroll in a plurality of user groups and lotteries, simultaneously.

The overall method of the present invention is executed by the above-described system and begins by receiving an interaction requests from an arbitrary account with the remote server (Step C). The arbitrary account is from the plurality of user accounts and represents a single instance of an arbitrary user interacting with the method of the present invention. The interaction request is a command issued by the arbitrary user through their corresponding user PC device. Further, the interaction request is at least one command selected from the group comprising a generate group command, a find group command, a message other user command, a verify account command, and a set buy-in amount command. The overall method of the present invention continues by executing a user verification process for the arbitrary account with the remote server in order to identify at least one matching group (Step D). The user verification process enables the method of the present invention to verify if the user associated to the user account has sufficient credentials and permissions to access any lotteries managed by the remote server. Additionally, the user verification process identifies the user groups whose selection criteria overlaps with the arbitrary user's eligibility information as the matching group. The overall method of the present invention continues by executing a lottery configuration process for the matching group with the remote server in order to determine a buy-in amount and an event window (Step E). The lottery configuration process enables one or more users in the matching group to determine the cost of a lottery ticket as well as the time and dates that the lottery will be held. Once the event window and buy-in amount are determined, the method of the present invention enables additional users to buy into the lottery. This buy in period can be selected by one or more users during the lottery configuration process. At the end of the buy in period, the overall method of the present invention continues by executing a randomized selection process with the remote server in order to determine a winning account from among the user accounts in the matching group (Step F). The random selection process randomly picks at least one user account to be the winning account. The winning account then receives a payout from a central reward pool that is funded by all users in the matching group. The overall method of the present invention continues by displaying a visual representation of the randomized selection process with the user PC device associated to the arbitrary account. Thus, the arbitrary user is able to monitor the progress of the lottery and enjoy an interactive infotainment rendering of the selection process.

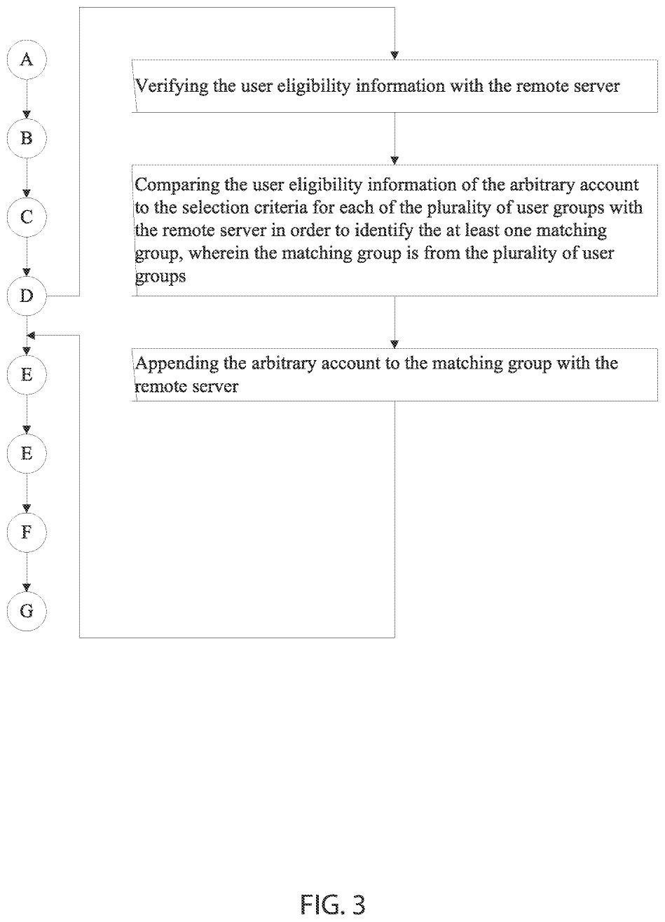

Referring to FIG. 3, the method of the present invention further comprises a subprocess for adding new user accounts to an arbitrary user group based on a variety of selection criteria. This subprocess begins by verifying the user eligibility information with the remote server. Accordingly, the veracity of data points in the user's user account is tested to determine if the user should be eligible to access the lotteries managed by the method of the present invention. Additionally, corporate, social, and governmental standards may be used to dictate lottery access. Once the user account is verified, the subprocess continues by comparing the user eligibility information of the arbitrary account to the selection criteria for each of the plurality of user groups with the remote server in order to identify at least one matching group from the plurality of user groups. Thus, the eligibility criteria of the user account specify what user groups and what lotteries the user account is able to access. The subprocess continues by appending the arbitrary account to the matching group with the remote server. Accordingly, the user account is given access to the corresponding lotteries. Once this process is completed, the user is presented with a graphical representation of all lotteries they can access. Further, these lotteries may be sorted and searched based on relevant datapoints in the user's eligibility information.

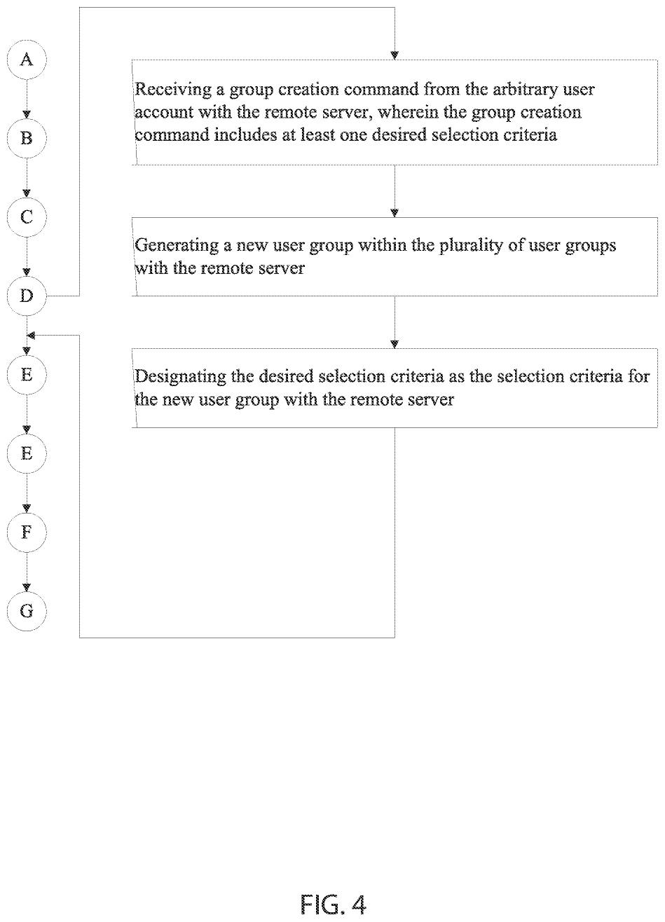

Referring to FIG. 4, the method of the present invention is designed to give users multiple options interacting with lotteries and user groups. For example, the method of the present invention includes a subprocess that enables a user to create a new group and invite other users to participate. This subprocess begins by receiving a group creation command from the arbitrary user account with the remote server. The group creation command includes at least one desired selection criteria that is used to instruct the remote server on how to structure and populate the new user group. The subprocess continues by generating a new user group within the plurality of user groups and then designating the desired selection criteria as the selection criteria for the new user group with the remote server. The user who issued the group creation command becomes the primary account and is able to manually invite additional user accounts to join the user group. Additionally, the new user group may be set to open or closed. In the open state any user account with the appropriate eligibility information is able to join the new user group. In the closed state, access to the new user group is invite only. In some embodiments, a bonus incentive is managed by the remote server and transferred to the financial account of the primary account. Thus, incentivizing group creation and community participation.

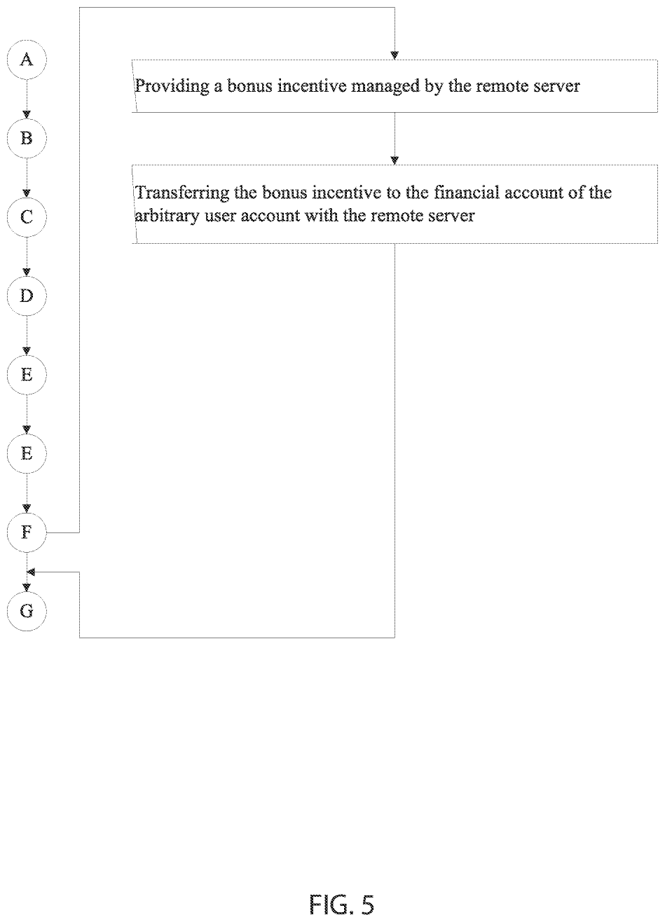

Referring to FIG. 5 through FIG. 9, the method of the present invention is designed to give users control over the lotteries. To that end, the method of the present invention includes a subprocess that enables the users within the matching group to set the price and timetable for the lottery. This subprocess begins by prompting each user account in the matching group to select a desired buy-in amount and a desired event window with the user PC device. The event window is the length of time for which the lottery will run. The subprocess continues by calculating a final buy-in amount and a final event window with the remote server based on the desired buy-in amount and the desired event window received from each user account in the matching group. Thus, all users in the matching group are able to participate in choosing the cost of entry and the duration of each lottery. In some embodiments, the final buy-in amount and the event window are selected based on an average of the desired buy-in amounts and event windows. In other embodiments, the users vote on these variables. In supplemental embodiments, the primary account may set the buy-in amount and event window. The subprocess continues by transferring the final buy-in amount from the financial account of each user account in the matching group into a reward pool with the remote server. Thus, all funds are immediately allocated and accounted for. The method of the present invention randomly selects the winning account from among the user accounts in the matching group and then transfers the reward pool into the financial account of the winning account with the remote server. In some embodiments, a portion of the reward pool is subtracted as a service fund by the remote server. Once the lottery is completed, the present invention continues by sending a lottery result notification to the winning account with the remote server. Thus, users who are not actively watching the graphical representation of the lottery are able to be aware of lottery results. Supplemental embodiments of the present invention are designed to place limits on user spending based on available credit and other information provided by the financial account. Thus preventing the users from incurring financial hardships by participating in lotteries provided by the method of the present invention.

Although the invention has been explained in relation to its preferred embodiment, it is to be understood that many other possible modifications and variations can be made without departing from the spirit and scope of the invention as hereinafter claimed.

What is claimed is:

1. A method for executing a user-guided lottery, the method comprising the steps of:
(A) providing a plurality of user groups managed by at least one remote server, wherein each user group includes a selection criteria;
(B) providing a plurality of user accounts managed by the remote server, wherein each user account is associated to a user personal computing (PC) device and a financial account, and wherein each user account includes user eligibility information;
(C) receiving an interaction requests from an arbitrary account with the remote server, wherein the arbitrary account is from the plurality of user accounts;
(D) executing a user verification process for the arbitrary account with the remote server in order to identify at least one matching group, wherein the matching group is from the plurality of user groups;
(E) executing a lottery configuration process for the matching group with the remote server in order to determine a buy-in amount and an event window;
(F) executing a randomized selection process with the remote server in order to determine a winning account, wherein the winning account is one of the user accounts in the matching group; and
(G) displaying a visual representation of the randomized selection process with the user PC device associated to the arbitrary account.

2. The method for executing a user-guided lottery, the method as claimed in claim 1 comprising:
verifying the user eligibility information with the remote server;
comparing the user eligibility information of the arbitrary account to the selection criteria for each of the plurality of user groups with the remote server in order to identify the at least one matching group, wherein the matching group is from the plurality of user groups; and
appending the arbitrary account to the matching group with the remote server.

3. The method for executing a user-guided lottery, the method as claimed in claim 1 comprising:
receiving a group creation command from the arbitrary user account with the remote server, wherein the group creation command includes at least one desired selection criteria;
generating a new user group within the plurality of user groups with the remote server; and
designating the desired selection criteria as the selection criteria for the new user group with the remote server.

4. The method for executing a user-guided lottery, the method as claimed in claim 3 comprising:
providing a bonus incentive managed by the remote server; and
transferring the bonus incentive to the financial account of the arbitrary user account with the remote server.

5. The method for executing a user-guided lottery, the method as claimed in claim 1 comprising:
prompting each user account in the matching group to select a desired buy-in amount and a desired event window with the user PC device;
calculating a final buy in amount and a final event window with the remote server based on the desired buy-in amount and the desired event window received from each user account in the matching group; and
transferring the final buy-in amount from the financial account of each user account in the matching group into a reward pool with the remote server.

6. The method for executing a user-guided lottery, the method as claimed in claim 1 comprising:
providing a reward pool managed by the remote server;
randomly selecting the winning account from among the user accounts in the matching group; and
transferring the reward pool into the financial account of the winning account with the remote server.

7. The method for executing a user-guided lottery, the method as claimed in claim 1 comprising:
providing a reward pool managed by the remote server;
allocating a portion of the reward pool as a service fund with the remote server; and
transferring the remainder of the reward pool into the financial account of the winning account with the remote server.

8. The method for executing a user-guided lottery, the method as claimed in claim 1 comprising:
sending a lottery result notification to the winning account with the remote server.
